(19) United States
(12) Patent Application Publication
(10) Pub. No.: US 2013/0316749 A1
(43) Pub. Date: Nov. 28, 2013

(54) WIRELESS DATA PIPELINE

(71) Applicants: Sayed-Amr El-Hamamsy, Calgary (CA); Rashed Haydar, Calgary (CA)

(72) Inventors: Sayed-Amr El-Hamamsy, Calgary (CA); Rashed Haydar, Calgary (CA)

(73) Assignee: SRD INNOVATIONS INC., Calgary, AB (CA)

(21) Appl. No.: 13/479,179

(22) Filed: May 23, 2012

(51) Int. Cl. H04B 7/00

(52) U.S. Cl. 455/500

(57) ABSTRACT

System and method for retrieving data from distributed nodes using radio. Data is transmitted through a mesh of nodes to aggregators, and may be transmitted through a mesh of aggregators to higher level aggregators. High level aggregators are arranged in pipelines and configured to transmit and receive simultaneously to maximize information relaying capacity.

### TECHNICAL FIELD

Data collection from distributed nodes.

### BACKGROUND

Seismic surveys are extensively used in the oil and gas industry to understand the subsurface and to provide structural images of the geological formation within the earth using reflected sound waves. The results of the survey are used to identify reservoir size, shape and depth as well as porosity and the existence of fluids. Geophysicists and geologists use this information to pinpoint the most likely locations for successfully drilling for oil and natural gas.

The seismic survey is conducted by placing a large number of geophones in the area of interest. They are set up in lines or in grids. Using shakers or small explosives, the ground is shaken and the geophones acquire the reflected sound data from the different sub-layers in the ground. FIG. 1 shows an example of a small portion of a 3-D Survey showing nodes 10 (or geophones) located 50 m apart in lines 12 that are separated by 300 m. Each node represents a geophone which could collect one or three components of data. A huge amount of data is collected in a given seismic survey that can cover 40 sq km and take days to gather. The conventional method of gathering this data is to have cables connecting the geophones back to a central field unit. These cables and other ground equipment can weigh up to 25 tons and requires a huge effort to deploy as well as to troubleshoot during operations. It has been estimated that 25-50% of the installation time and effort is consumed in laying down the cables. Similarly, 50-70% of the troubleshooting effort and time relates to cable issues.

A few years ago, I/O introduced a system where the majority of the cables have been eliminated. It uses a field station connected to up to 6 geophones via cables to store the data from those geophones on an internal hard drive. The station is controlled via a wireless link that also provides a means for quality control (QC). The data must be collected either at the device using a field unit or when the geophones are retrieved at the end of the acquisition process.

Since then the industry has also begun moving towards another compromise solution which is to roll out cable-less surveys using autonomous or blind shooting geophones. These geophones have enough data storage on board, GPS receivers and batteries that allow them to be deployed in the field for the duration of the survey. They use various means of time-stamping the samples of data. In some cases they collect data on a pre-determined timing, in other cases, they continuously collect data and then the data is correlated in time to the dynamite explosion or the vibroseis excitation. In all these cases the data remains in the field until the geophones are collected. The data is then transcribed and stored at the Data Collection Center (DCC).

The drawback of keeping the data in the field in this manner is that any problems are discovered too late and may require re-shooting a portion of the survey which is a huge expense. Problems can occur when units are stolen, or if they fail to operate properly or if the batteries die.

It would therefore be highly advantageous to the seismic survey companies to be able to get back to the instantaneous data gathering ability of the cabled geophone systems without having to bear the burden of deploying and maintaining the cables in the field.

### SUMMARY

There is disclosed a system for collecting data from a set of distributed nodes, the system comprising plural aggregator nodes, each aggregator node of the plural aggregator nodes configured to receive data from a subset of the set of distributed nodes, the system also comprising pipeline nodes arranged to form one or more data pipelines to relay data to a data collection center, at least one pipeline node of each of the one or more data pipelines being an aggregator node of the plural aggregator nodes or receiving data from one or more of the plural aggregator nodes, a first data pipeline of the one or more data pipelines comprising a first pipeline node, a third pipeline node, and a second pipeline node intermediate between the first pipeline node and the third pipeline node, the second pipeline node configured to receive data from the first pipeline node on a first frequency using a first radio using a first antenna and to retransmit the received data to the third pipeline node on a second frequency using a second radio using a second antenna, the second pipeline node being configured to transmit on the second frequency using the second radio using the second antenna concurrently with receiving on the first frequency using the first radio using the first antenna.

In various embodiments, there may be included one or more of the following features: The first antenna and the second antenna may be directional antennas that are orientable both azimuthally and in elevation. The first antenna and the second antenna may have sufficient gain to permit links of 1 km. The first antenna and the second antenna may have sufficient gain to permit links of 3 km. The first antenna and second antenna may be mountable on a tripod deployable to a height of at least 2 m. The first radio and second radio may be mountable on the tripod. The first and second radio may be integrated in a single printed circuit board and use an internal communications bus to transfer the data between the first and second radio. The second aggregator node may be an aggregator node of the plural aggregator nodes and may further comprise a data receiving element and an aggregating element, the data receiving element configured to receive data from the second pipeline node's respective subset of the set of distributed nodes and to send the received data to the aggregating element, the aggregating element configured to aggregate the received data and send the aggregated data to the second radio for transmission using the second antenna. The data receiving element may be a radio transceiver. The radio transceiver may be configured to receive at a different frequency than the first and second frequencies. The data collection element may be a wired connection to one or more of the respective subset of the set of distributed nodes. The system may further comprise low level aggregator nodes and sensor nodes of the set of distributed nodes, the low level aggregator nodes each collecting data from a respective subset of the sensor nodes and the aggregator nodes of the plural aggregator nodes each receiving data from a respective subset of the low level aggregator nodes. The subset of the sensor nodes corresponding to a low level aggregator node of the low level aggregator nodes may form a mesh to relay data to the corresponding low level aggregator node. The subset of the low level aggregator nodes corresponding to an aggregator node of the plural aggregator nodes may form a mesh to relay data to the corresponding aggregator node of the plural aggregator nodes. The first data pipeline may further comprise a fourth pipeline node, the third pipeline node being configured to receive data from the second pipeline node on the second frequency and to concurrently retransmit the data to the fourth pipeline node on the first frequency. The one or more data pipelines may further include a second data pipeline adjacent to the first data pipeline, each pipeline node of the second data pipeline transmitting on one of a third frequency and a fourth frequency, the third frequency and the fourth frequency being different from the first frequency and the second frequency. The one or more data pipelines may further include a third data pipeline adjacent to the second data pipeline, each pipeline node of the third data pipeline transmitting on one of a fifth frequency and a sixth frequency, the fifth frequency and the sixth frequency being different from the first, second, third and fourth frequencies. The one or more data pipelines may further include a fourth data pipeline adjacent to the third data pipeline, each pipeline node of the fourth data pipeline transmitting on one of the first frequency or the second frequency. The data collection center may be located generally in the center of the set of distributed nodes. The distributed nodes may be seismic sensor nodes. The data collection center may comprise an antenna for each data pipeline configurable to receive data from the respective data pipeline. The data collection center may comprise an optical fiber, cable, or other wired connection to a pipeline node of each data pipeline.

There is also disclosed a method of receiving data at a data collection center from multiple radio transmitters, the radio transmitters configurable to transmit concurrently, and each radio transmitter configurable to transmit at a respective frequency, and each radio transmitter configurable to transmit a polarized signal, at least one of the radio transmitters transmitting from a generally a first direction from the data collection center, and at least one of the radio transmitters transmitting from generally a second direction from the data collection center, the second direction being different from the first direction, the method comprising placing a receive antenna at the data collection center for each of the multiple radio transmitters, configuring each radio transmitter generally in the first direction from the data collection center to transmit a signal at a frequency different from the respective frequencies of any other radio transmitters of the multiple radio transmitters generally in the first direction, configuring each radio transmitter generally in the second direction from the data collection center to transmit a signal at a frequency different from the respective frequencies of any other radio transmitters of the multiple radio transmitters generally in the second direction, at least one radio transmitters generally in the second direction from the data collection center transmitting on substantially the same frequency as at least one radio transmitter generally in the first direction from the data center, but using a different polarization, and configuring each receive antenna to receive at the respective frequency and polarization of the respective radio transmitter. In an embodiment, the method may be used in a seismic survey.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a diagram of a small portion of a 3-D Survey showing nodes (or geophones);

FIG. 2 is a diagram of a survey in open terrain showing a mesh of Level 1 Aggregators and the nodes they are connected to;

FIG. 3 is a diagram of a survey in wooded terrain showing the location of the Level 1 Aggregators relative to the nodes;

FIG. 4 is a diagram showing (A) a general view of a survey of 36 km by 3.9 km wide divided into 10 tiles and (B) a detailed view of the topmost tile showing the line segments representing 6 geophones in each sub-mesh;

FIG. 5 is a diagram showing a frequency plan used to separate the pipelines of L2 aggregators;

FIG. 6 is a diagram showing a survey in open terrain with 10,000 nodes separated by 50 m, with line-to-line separation of 300 m;

FIG. 7 is a diagram showing an additional L2 Pipeline in an open survey;

FIG. 8 is a diagram showing part of a survey using L1 Aggregators near the mid-line of the survey to carry some of the data to the DCC;

FIG. 9 is a schematic of a frequency plan to bring data from the survey to the DCC;

FIG. 10 is a schematic showing the termination of an open terrain survey; and

FIG. 11 is a schematic diagram of a pipeline node.

### DETAILED DESCRIPTION

In this disclosure we describe a wireless data pipeline. The pipeline is capable of transporting a high volume of data over long distances. The pipeline is preferably easy to deploy, in a variety of terrains, and is scalable in its capacity to carry data. Although, the application described here is mostly for Seismic Surveys, this should not necessarily be construed as a limitation on all embodiments of the invention.

SRD Innovations has developed a hybrid mesh (hyMESH™) concept to collect seismic survey data from the field in real-time. hyMESH™ incorporates sub-meshes connected at one end or another to a backhaul or aggregator unit which in turn connects to the Central Computer via a long distance link or a set of longer range meshed aggregators using different frequencies. The Seismic Survey produces a huge amount of data in a synchronized manner during operation. In extreme cases, a survey could involve as many as 6,000 geophones, each geophone collecting three components, and each component producing 4 Bytes of data every millisecond. The full data rate from the whole survey under these circumstances works out to:

6,000 nodes×4 Bytes×3 Components×8 bits/Byte+1 msec=576 Mbps

In general the data requirements are less severe for practical cases. For example the sampling rates could be lower (e.g. 2 msec/sample), only one component may be acquired per geophone, or the number of geophones could be much smaller.

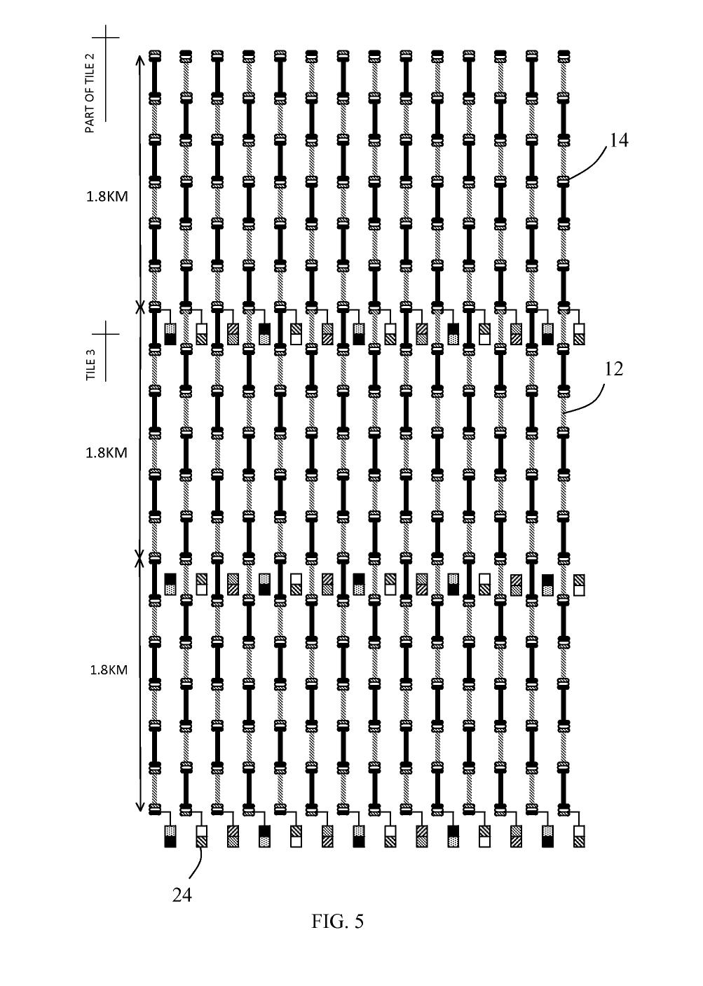

A survey uses a set of distributed nodes to collect information. In this disclosure, an example survey will be laid out as follows: 14 lines of 720 nodes or geophones (or 10,080). The geophones are spaced 50 m apart along the line and the lines are set 300 m apart from each other. The survey area is therefore 3.9 km wide by 36 km long. We divide the survey into 10 tiles. Each tile is 3.9 km wide by 3.6 km long. The DCC is placed for the purpose of this example at the center of the survey as shown in FIG. 4.

In our example, the geophones are single component geophones, collecting samples every 1 msec. In that case the capacity of the network has to be equal to:

10,080 nodes×4 Bytes×1 Component×8 bits/Byte+1 msec=322.56 Mbps

In United States published applications nos. 2011/0170443, 2009/0265140 and 2009/026968 there are disclosed various elements of a hybrid mesh system. The content of these applications is incorporated by reference herein.

In these applications, we described how we would connect the nodes to each other using a wireless mesh network. Once we have a number of nodes meshed together the data would be collected by a backhaul unit connected to the closest node in the mesh. It is the purpose of this disclosure to describe a novel method for providing the backhaul. In our previous description, we intended to use long distance point to point wireless connections to bring the data back to the DCC. However, there are practical limitations to that approach as it could require very high towers and highly directional antennas.

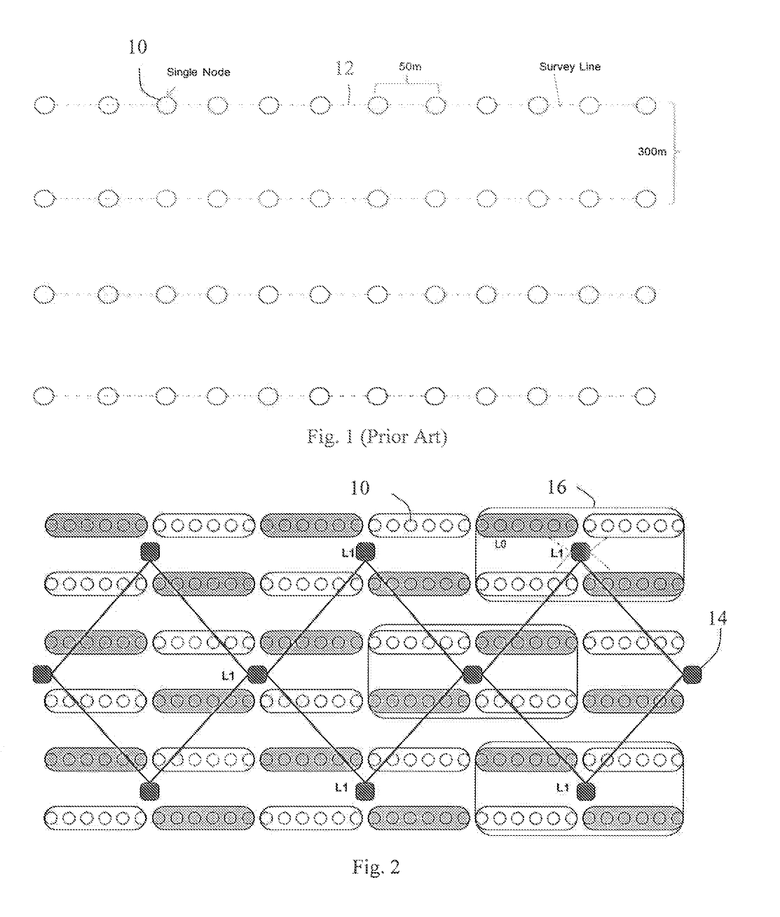

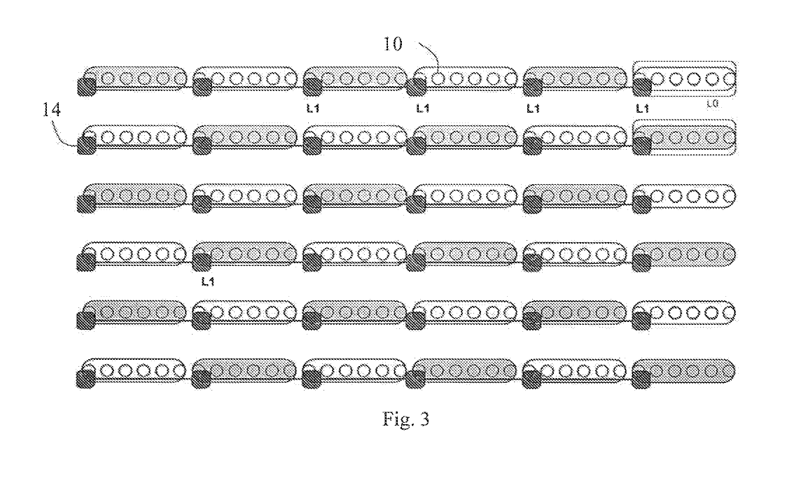

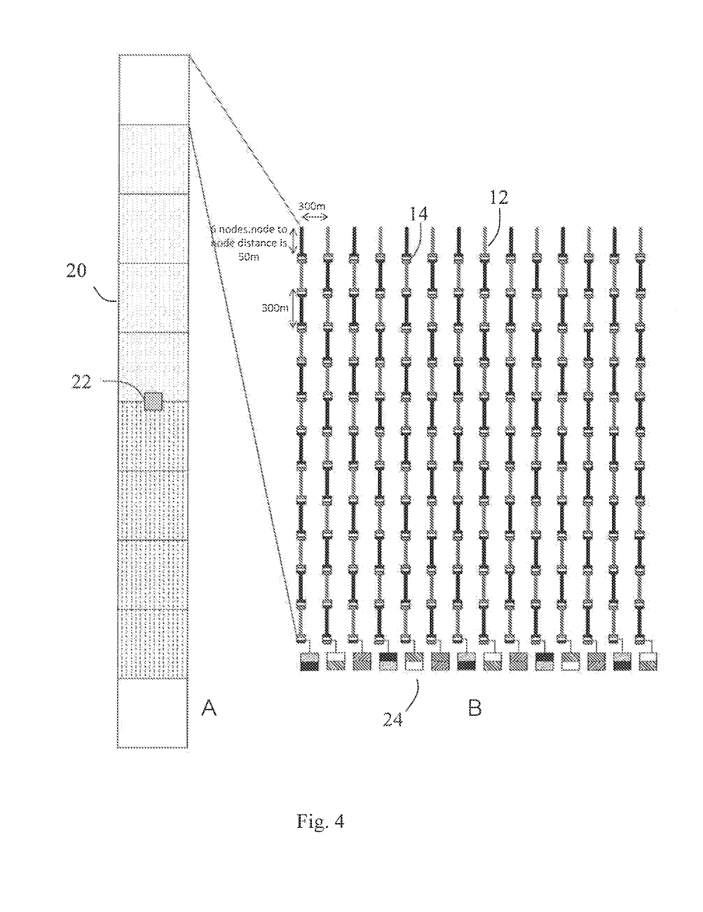

In another disclosure we aggregate the data from the nodes into another mesh network which we will call a Level 1 mesh (FIGS. 2 and 3). FIG. 2 is a diagram of a survey in open terrain showing a mesh of Level 1 Aggregators 14 and the nodes they are connected to. Each L1 Aggregator 14 connects to 24 nodes 10 in this case. A group of nodes 10 connected to a single L1 aggregator 14 is indicated by a rounded rectangle labeled with reference numeral 16. The distance between L1 Aggregators for a survey using 300 m line separation and 50 m node separation is about 460 m. The shadings indicate different frequencies of operation. FIG. 3 is a diagram of a survey in wooded terrain showing the location of the Level 1 Aggregators 14 relative to the nodes. The Level 1 mesh in this case runs along cut lines in the woods that are cut to permit access by the crews. In this case, the distance between L1 Aggregators 14 is about 300 m as each connects to 6 nodes 10 set 50 m apart. The shadings indicate different frequencies of operation. In this case the L1 aggregators use different frequencies from the ones used by the nodes and use higher gain antennas placed on a pole or tripod of about 2 m in height. By doing that we are able to place L1 Aggregators at 300-500 m intervals. However, the L1 Aggregators suffer from the same limitation as the nodes, which is that network reaches its capacity after a number of hops. This occurs because of two effects: first, the increased number of hops decreases the overall throughput of the network. Any node can only transmit or receive at any given time. Also, a node that's close enough to another transmitting node cannot receive from a, third node during that time because of collisions, Second, each node adds more data to the network; therefore it increases the amount of data that needs to be transmitted in a given time.

The nodes and L1 Aggregators therefore provide two parallel paths that can transmit the data a certain distance, but they run out of capacity before being able to deliver the complete data set to the DCC.

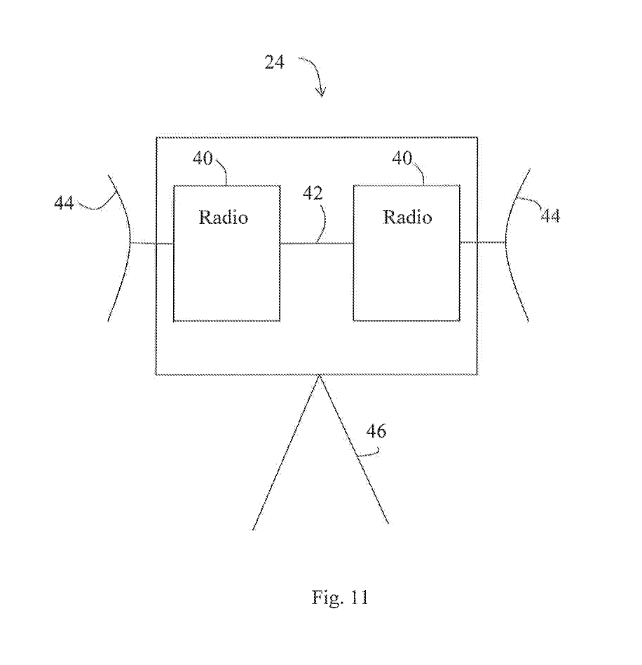

In an embodiment, we use a pipeline node 24 to be the primary means of transporting the data over long distances. The pipeline mode may in an embodiment bean aggregator, which we call a Level 2 Aggregator (L2 Aggregator). FIG. 11 shows a schematic diagram of a pipeline node 24. These pipeline nodes include two wireless modules 40, which could be built on a single printed circuit board (not shown), capable of operating in the different channels of the 5.8 GHz unlicensed band. The wireless modules are connected by an internal communications bus 42, so that data received on one radio can be transmitted immediately on the other radio. There are many non-overlapping channels in the 5.x GHz band, the data pipeline would take advantage of as many as are available under local regulations. However, in our example, we will restrict ourselves to the 7 channels in the 5.8 GHz band. We can have 3 distinct pairs of channels to use in each pipeline and have a spare channel for other uses. In the embodiments described, level 2 aggregators are used to make data pipelines, but in other embodiments, higher level aggregators could be used, or level 1 aggregators could be used. A pipeline may include nodes that serve purely to relay data and do not do any aggregation. In order for a pipeline to transport data from aggregator nodes, at least one pipeline node of the pipeline must be an aggregator node or receive data from an aggregator node. The system has plural aggregator nodes each configured to receive data from a subset of the set of distributed nodes. The plural aggregator nodes may comprise level 1, level 2, and higher level aggregator nodes, and an aggregator node may relay data from other aggregator nodes of the same level and may receive data from lower level aggregator nodes and/or non-aggregator nodes. A pipeline may comprise multiple pipeline nodes, for example, a first pipeline node, a third pipeline node, and a second pipeline node intermediate between the first pipeline node and the third pipeline node. In order to simultaneously transmit and receive, the second pipeline node may be configured to receive data from the first pipeline node on a first frequency using a first radio using a first antenna and to retransmit the received data to the third pipeline node on a second frequency using a second radio using a second antenna. The second pipeline node may thus be configured to transmit on the second frequency using the second radio using the second antenna concurrently with receiving on the first frequency using the first radio using the first antenna. This may be continued for example with a fourth pipeline node, in which the third aggregator pipeline node is configured to receive data from the second aggregator pipeline node on the second frequency and to concurrently retransmit the data to the fourth aggregator pipeline node on the first frequency.

Each pipeline node (in an embodiment, an L2 aggregator) may have two directional antennas 44 (e.g. panel antennas with a 20 Deg beam width and 20 dBi gain). In this embodiment each antenna can be independently pointed both azimuthally and in elevation. Each antenna is connected to one of the two radios. The pipeline node may be mounted on a tripod 46 to support the pipeline node at a height of 2 m or more. The antennas alone may be mountable on a tripod, the radios and antennas may be mountable on the tripod, or preferably the whole pipeline node may be mountable on the tripod.

The pipeline node as described above is then capable of simultaneously transmitting and receiving. This means that the pipeline does not incur the loss in throughput characteristic of a multi-hop system wherein the unit is either receiving or transmitting at a given time. This results in a reduction of the throughput with every additional hop. A multi-hop system of pipeline nodes will only suffer slight throughput drop due to whatever overhead still remains in passing data from one radio to another. This overhead is small.

In order to meet the data capacity required by the size of the survey, multiple pipelines are used. The frequency plans which enable the use of multiple pipelines running in parallel in a fairly confined area are described in the next section. In particular, solutions are described in detail for surveys in wooded terrain with cut-lines and in open terrain.

The nodes in a tile will have their data collected by an L2 Aggregator placed at the bottom of the tile. There are typically as many collecting points in each tile as there are pipelines in the survey. The pipelines bringing the data from the top to the DCC start at the bottom of the topmost tile (relative to the DCC) with the first collecting L2 Aggregator (or vice versa for the pipelines bringing data from the bottom half of the survey). Then we have one or two pipeline nodes which transport the data to the collecting L2 Aggregator at the bottom of the next tile. At that point, the L2 Aggregator at the bottom of that tile collects the tile's data and adds it to the data flow in the pipeline. An L2 aggregator that acts as a collector may have a data receiving element, for example a radio transceiver or wired connection, and an aggregating element such as a processor. The data receiving element may receive data from a lower mesh level such as lower level aggregators or from sensor nodes. The data receiving element may allow the L2 aggregator to participate in a mesh of non-pipeline aggregator nodes, and may receive at a different frequency than the frequencies used by antennas 44. The data receiving element may send the received data to the aggregating element, the aggregating element configured to aggregate the received data and send the aggregated data to a radio 40 for transmission using an antenna 44 for transmission to the next pipeline node in the pipeline.

L2 Aggregator capacity calculations: We estimate the capacity of the L1 Aggregators to be about 12 hops to maintain a throughput equal to the data being collected by those 12 L1 Aggregators. The L1 Aggregators are each collecting data from 6 nodes, which are sampling at 32 kbps. Therefore, each line of nodes in a tile supply the following amount of data to the L2 Pipeline:

12 L1×6 nodes×32 kbps=2.304 Mbps

As the pipeline travels through the 5 tiles, the total data per pipeline through the 5 tiles:

5 Tiles×2.304 Mbps=11.52 Mbps

Each pipeline of L2 Aggregators can carry 22 Mbps of data. In the current example we can have as many as 14 pipelines in each half of the survey (one for each line of nodes). Therefore we have enough capacity to transport

28 lines×22 Mbps/line=616 Mbps

The total amount of data produced by the 10,080 nodes in the current survey is equal to: 322.56 Mbps. Therefore the L2 pipelines are capable of handling that data rate.

This document discloses a means of pipelining the data from the various nodes and aggregators in the field and of transporting it back to the DCC. The disclosure includes a special wireless device, the frequency plan and network structure required to transport the data from the vast area of the survey to the DCC.

A data pipeline may include one or more of the following features and concepts:

Wireless units (pipeline nodes, which may be L2 Aggregators) which contain two radios connected internally, such that the data received on one unit is transmitted immediately on the other unit.

Two directional antennas which can be independently pointed both azimuthally and in elevation.

The antennas may have sufficient gain to permit links of 1-2 km, or 1-3 km.

The radios and antennas may be mounted on a tripod that can be deployed to a height of 2 m or more.

The pipeline nodes automatically create a pipeline network with other pipeline nodes.

The pipeline nodes are capable of being connected either wirelessly or through a wired means to another mesh level to collect the data from that second mesh level.

The pipeline nodes in a single pipeline transmit and receive on a pair of non-overlapping channels. For example, unit 1 transmits on channel 1 and receives on channel 2, unit 2 receives on channel 1 and transmits on channel 2 and so on.

Multiple lines are used in parallel by using frequency separation. For example, if one line uses channels 1 and 2, the next line uses channels 3 and 4, and the one after uses channels 5 and 6. After three lines the pattern can be repeated with a very low probability of interference due to the distance between lines and the use of directional antennas.

For Seismic Surveys in particular: Placing the DCC in the center of the survey helps increase the capacity of the data pipeline.

Pipelines carrying data from the bottom of the survey (represented by the dashed lines in FIG. 4A) and lines coming from the top of the survey (dotted lines in FIG. 4A) use alternate channels to avoid interfering with each other as the pipelines converge on the center line of the survey.

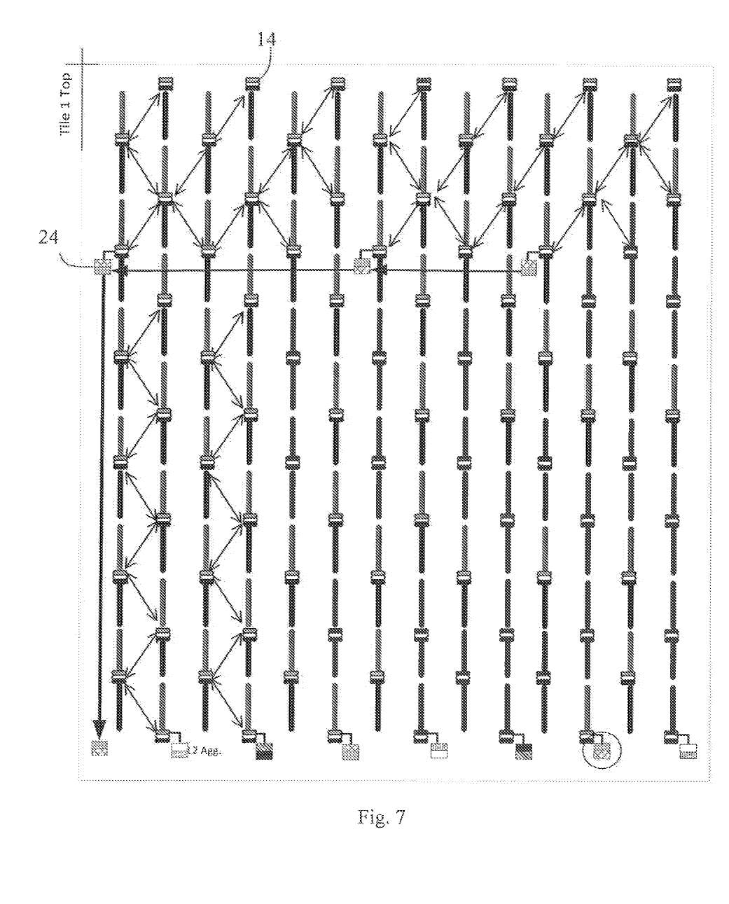

The data is converged to the DCC wirelessly by using multiple links created by for example placing a receive antenna for each line, operating each on a different frequency, separating the antennas spatially around the perimeter of the DCC, and using vertical and horizontal polarization to further isolate links operating at the same frequency but converging from different directions (FIG. 7 for example).

In cases where it is not possible to converge the data wirelessly to the DCC, alternative solutions are used for the final link or final few hundred meters only: Optical Fiber connection between the pipeline end-point and the DCC; Local storage on hard drives of the data at the end-point of the DCC; Using cables or other wired means to bring the data to the DCC.

Seismic Survey in Wooded Terrain with Cut-Lines: Although seismic surveys occur over very large areas (e.g. a survey can be 36 km long by 3.9 km wide), the line to line separation of L2 Aggregators or Data Pipelines would still be close enough to cause potential interference.

Therefore, we propose a variety of frequency plans to help avoid interference between lines in each half of the survey. We also have to modify that plan to account for the L2 pipelines coming from the other half of the survey.

In FIG. 4, the overall survey is shown as well as the detail of the topmost tile. We take advantage of the L1 Aggregators to collect the data at the bottom of that tile. This allows us to reduce the length of the pipeline. FIG. 4 shows (A) a general view of a survey of 36 km by 3.9 km wide divided into 10 tiles 20, where the gray square in the middle of the survey represents the location of the DCC 22 and (B) a detailed view of the topmost tile showing the line segments representing 6 geophones in each sub-mesh, operating on two different channels indicated by the light and dark shading. In the wooded implementation each 6 nodes 10 are connected to a Level 1 (L1) Aggregator 14. The nodes are set at 50 m from each other in the vertical direction, and the line-to-line separation is 300 m. At the bottom of the tile the first set of L2 aggregators 24 is shown connected to the last L1 aggregator in that tile. The data is transported down the chain of L1's and then passed on to the L2 aggregator 24. The L2 aggregators then pipeline the data to the DCC 22.

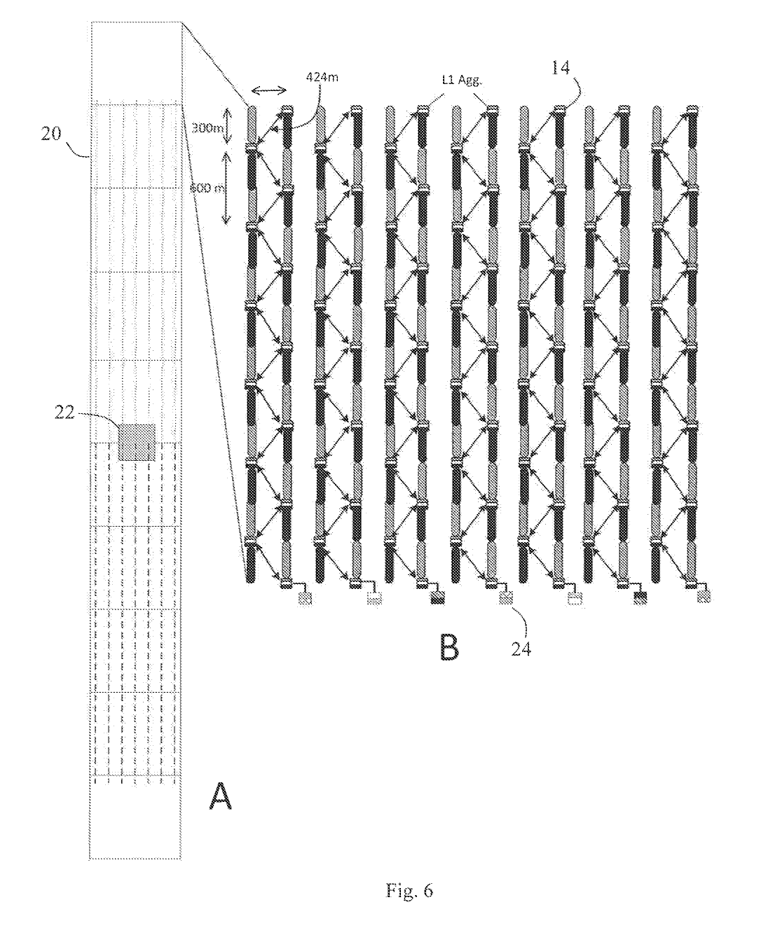

FIG. 5 shows the pipeline as it goes through the middle tiles. The two frequencies of operation of each of the pipeline nodes are indicated by the pair of shadings shown. By using 6 of the non-overlapping channels that exist in the 5.8 GHz band we can create three non-interfering lines next to each other. However, these need to be repeated since we require 14 pipelines. To further reduce the possibility of interference between lines using the same frequencies, we also reverse the order of the two frequencies as shown.

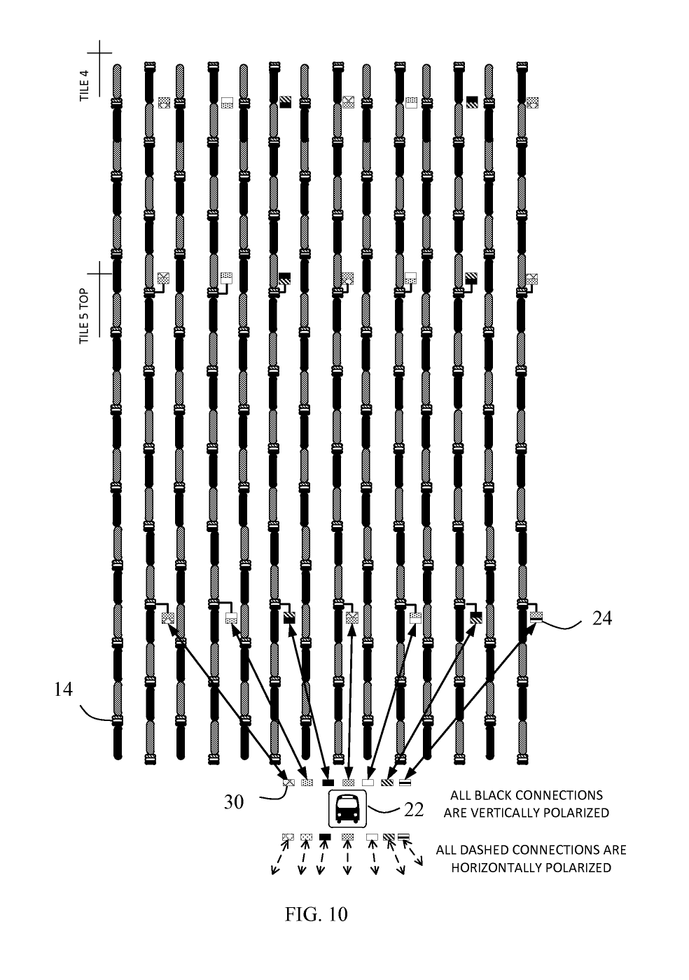

Although in our drawings for simplicity of illustration we show the L2 Aggregator collecting the data from the given survey tile at the bottom of the tile, this is a simplification for the purpose of illustrating the concept. In cases where topography of the terrain, requires placing the collecting L2 Aggregator 24 in a different spot this is simply accommodated by ensuring that the end point of the L1 mesh is located where the collecting L2 Aggregator is placed and having the data flow in the mesh be towards the end point from two directions. FIG. 10 shows an example of such a situation where the L2 Aggregators are not placed at the end of the tile but a little further up.

Open Terrain Seismic Survey: FIG. 6 shows a similar survey to FIGS. 4 and 5 except that it is in open terrain. FIG. 6 is a diagram showing a survey in open terrain with 10,000 nodes separated by 50 m, with line-to-line separation of 300 m. This survey can use fewer L1 Aggregators 14 because they can communicate diagonally with each other. The distance between L1 Aggregators is 424 m. Once more we collect the data from one tile at the bottom of the tile. In this case we use a fewer number of L1 aggregators because we can connect them diagonally as shown in the diagram. If the data rates permit it we can reduce the number of L2 pipelines in each half of the survey to seven as shown. Each L1 aggregator collects data from two level 0 sub-meshes of 6 nodes each. Each L1 Aggregator collects 384 kbps and with 22 Mbps per hop throughput we can accommodate 12-13 hops. However, in our current example (10,080 nodes, sampling 4 Bytes of data every 1 millisecond) the required data rate is 322.56 Mbps while the data capacity of 14 L2 Pipelines is equal to: 14×22 Mbps=308 Mbps. Therefore we must increase the capacity of the L2 Pipelines by at least 14.56 Mbps by using one of two methods as follows:

(1) Add an extra pipeline of pipeline nodes 24 in each half of the survey (see FIG. 7). This extra pipeline in each half collects the data from a fraction of the nodes in the top tile. The L1 Aggregators 14 in that portion of the tile move the data towards several collecting L2 Aggregators. The collecting L2 Aggregators connect to their additional pipeline which is placed along one of the edges of the survey area. The number of L1 Aggregators that must be pipelined through this additional L2 pipeline is calculated as follows:

$$Minimum Number of L 1 Aggregators = \frac{14.56 Mbps}{0.384 Mbps} = 37.91 = 38$$

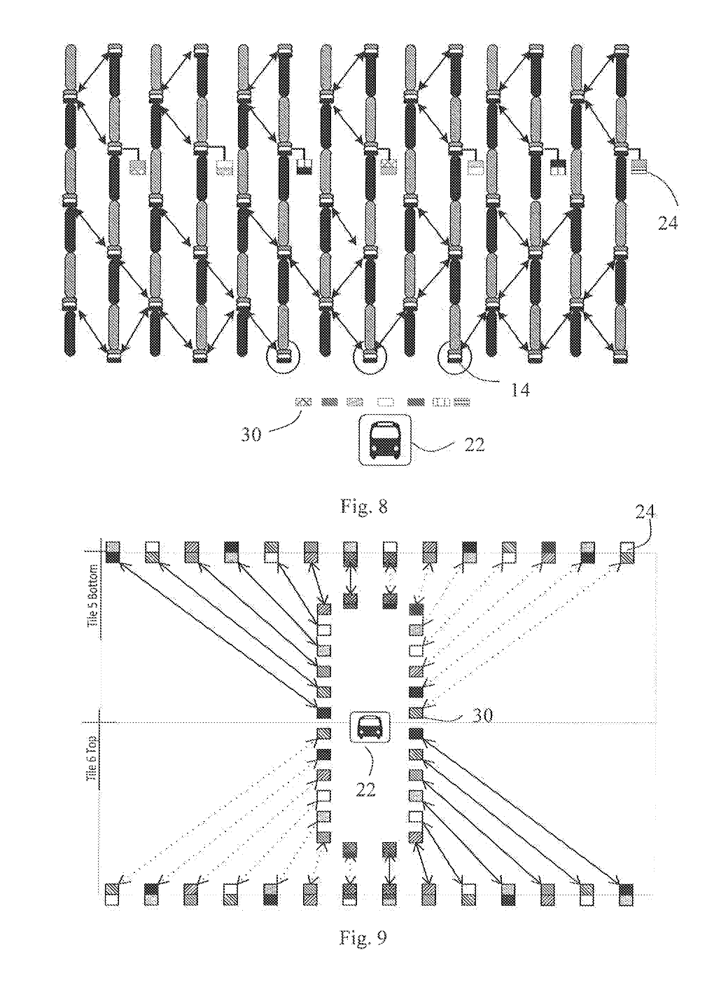

Therefore, a minimum of 19 L1 Aggregators in each half of the survey must be collected by the additional line. In FIG. 7, 27 L1 Aggregators are collected in the additional pipeline which satisfies the minimum requirement with a safety factor.
(2) Do not collect data from a portion of the last two tiles and use the L1 Aggregators to carry the data to the DCC for those portions (see FIG. 8). Using the same calculation, the closest 19 L1 aggregators in each half of the survey can be used to carry their data to the DCC.

FIG. 7 is a diagram showing an additional L2 Pipeline in an open survey which increases the overall network capacity by collecting data from a fraction of the nodes in the top tile. The arrows show the connections between the L1 Aggregators 14, the additional L2 Aggregators 24 may be placed as shown in the top to collect from all the nodes in the collection area across the width of the survey. The additional L2 Pipeline runs along the side of the survey to provide maximum isolation between it and the next line using the same frequency plan (circled in FIG. 7). A similar pipeline is added at the bottom half of the survey and would run up the right hand-side of the survey.

FIG. 8 shows a survey in which L1 Aggregators near the mid-line of the survey are used to carry some of the data to the DCC. This effectively increases the capacity of the L2 Pipelines and does not require additional equipment. The circled L1 Aggregators 14 are the end point for the data from the bottom 28 L1 Aggregators 14. The data can be transferred the last few hundred meters to the DCC 22 using wires, optical fibers, or it can be stored on location.

Terminating the L2 Pipeline at the Data Collection Center: The pipeline as described so far can bring the data all the way to the center line of the survey. However, it is our purpose to collect all the data at the DCC. Several issues occur because of that.

The first issue is that the pipelines coming from the bottom and top halves of the survey must not interfere with each other. To avoid that problem, care must be taken to ensure that the pipelines coming from the bottom of the survey and the ones coming from the top of the survey along the same cut-line operate on different channels to avoid interfering with each other. We number the pipelines from left to right. Pipelines coming down from the top of the survey use the frequency channels as follows: pipeline 1 transmits on Channel 1 and receives on channel 2 (written as 1-2 for short), pipeline two uses 3-4, pipeline 3 uses 5-6. Then the corresponding pipelines coming from the bottom half of the survey would use the following channel allocations: 6-5, 2-1, 4-3. Thus we avoid having lines from the bottom of the survey interfere with those from the top.

The second problem is that in wooded terrain, the pipelines were laid down along the vertical cut-lines used by the crew to deploy the survey. So at the end of the pipeline the data needs to be moved horizontally towards the DCC. Generally, there will be horizontal cut-lines or roads cut through the woods to permit the heavy equipment to reach the survey area. In general there would be such a road where the DCC is located. So at the end of the lines the data is pipelined along that road till it reaches the DCC. A possible frequency plan is shown in the figure. Horizontally and vertically polarized antennas 30 are also used to create further isolation between the channels. In cases where this is not feasible, we propose several alternative solutions: Optical Fiber connection between the pipeline end-point and the DCC; Local storage on hard drives of the data at the end-point of the DCC; Using cables or other wired means to bring the data to the DCC.

FIG. 9 shows the seventh non-overlapping channel of the 5.8 GHz band being used to connect the two middle pipelines to the DCC 22. This may not be needed as the pipelines may be close enough to the DCC that cables, optical fibers or some other methods may be used to replace that wireless link. FIG. 9 is a schematic of a frequency plan to bring data from the survey to the DCC. All seven frequency channels are used. Additionally, vertical and horizontal polarization of the antennas 30 is used to create further separation between the channels from the right side of the survey and the ones from the left. The vertical dimensions are exaggerated for illustration purposes. While the survey width could be 3-4 km, the vertical dimension could be about 50 m only. Dotted connections in FIG. 9 are horizontally polarized, solid connections are vertically polarized. In FIG. 9 and FIG. 10 data is collected at the data collection center from multiple radio transmitters (transmitters of pipeline nodes 24 at the ends of their respective pipelines). For maximum throughput the transmitters should transmit concurrently. Each transmitter transmits at a particular frequency, and in the embodiments of FIGS. 9 and 10, also with a particular polarization. The number of frequencies available is limited and in these embodiments more transmitters are needed than frequencies are available. Thus, the transmitters in a particular general direction from the DCC 22 can be given different frequencies from each other, but not every transmitter can be given a different frequency from all the others. In FIG. 9, the general directions in which each transmitter has a different frequency are upper left, upper right, lower left, and lower right, and in FIG. 10, upper and lower. In order to reduce interference between transmitters with the same frequency, a transmitter using a particular frequency in one general direction can use a different polarization than a transmitter using the same frequency in another general direction. In the embodiments shown, all the transmitters in a given general direction use the same polarization, but this is not essential. For each transmitter, a receive antenna is placed at the DCC and configured to receive at the frequency and polarization of the respective transmitter.

In the situation of an open terrain survey, as shown in FIG. 10, the last L2 Aggregators 24 can be placed a certain distance from the centerline of the survey and the last hop converges directly onto the DCC. Therefore it is generally easier to converge on the DCC in cases of open terrain.

FIG. 10 shows the termination of an open terrain survey. Because the terrain is open, diagonal connections can be made; therefore the last L2 Aggregator 24 in each pipeline can be placed as shown. The data flows to that L2 Aggregator from the pipeline and it collects data from the L1 Aggregators 14 which flow it both upwards and downwards. Solid connections are vertically polarized, dashed connections are horizontally polarized.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A system for collecting data from a set of distributed nodes, the system comprising plural aggregator nodes, each aggregator node of the plural aggregator nodes configured to receive data from a subset of the set of distributed nodes, the system also comprising pipeline nodes arranged to form one or more data pipelines to relay data to a data collection center, at least one pipeline node of each of the one or more data pipelines being an aggregator node of the plural aggregator nodes or receiving data from one or more of the plural aggregator nodes, a first data pipeline of the one or more data pipelines comprising a first pipeline node, a third pipeline node, and a second pipeline node intermediate between the first pipeline node and the third pipeline node, the second pipeline node configured to receive data from the first pipeline node on a first frequency using a first radio using a first antenna and to retransmit the received data to the third pipeline node on a second frequency using a second radio using a second antenna, the second pipeline node being configured to transmit on the second frequency using the second radio using the second antenna concurrently with receiving on the first frequency using the first radio using the first antenna.

2. The system of claim 1 in which the first antenna and the second antenna are directional antennas that are orientable both azimuthally and in elevation.

3. The system of claim 1 in which the first antenna and the second antenna have sufficient gain to permit links of 1 km.

4. The system of claim 1 in which the first antenna and the second antenna have sufficient gain to permit links of 3 km.

5. The system of claim 1 in which the first antenna and second antenna are mountable on a tripod deployable to a height of at least 2 m.

6. The system of claim 5 in which the first radio and second radio are mountable on the tripod.

7. The system of claim 6 in which the first and second radio are integrated in a single printed circuit board and use an internal communications bus to transfer the data between the first and second radio.

8. The system of claim 1 in which the second pipeline node is an aggregator node of the plural aggregator nodes and further comprises a data receiving element and an aggregating element, the data receiving element configured to receive data from the second pipeline node's respective subset of the set of distributed nodes and to send the received data to the aggregating element, the aggregating element configured to aggregate the received data and send the aggregated data to the second radio for transmission using the second antenna.

9. The system of claim 8 in which the data receiving element is a radio transceiver.

10. The system of claim 9 in which the radio transceiver is configured to receive at a different frequency than the first and second frequencies.

11. The system of claim 8 in which the data receiving element is a wired connection to one or more of the respective subset of the set of distributed nodes.

12. The system of claim 1 in which the system further comprises low level aggregator nodes and sensor nodes of the set of distributed nodes, the low level aggregator nodes each collecting data from a respective subset of the sensor nodes and the aggregator nodes of the plural aggregator nodes each receiving data from a respective subset of the low level aggregator nodes.

13. The system of claim 12 in which the subset of the sensor nodes corresponding to a low level aggregator node of the low level aggregator nodes forms a mesh to relay data to the corresponding low level aggregator node.

14. The system of claim 12 in which the subset of the low level aggregator nodes corresponding to an aggregator node of the plural aggregator nodes forms a mesh to relay data to the corresponding aggregator node of the plural aggregator nodes.

15. The system of claim 1 in which the first data pipeline further comprises a fourth pipeline node, and the third pipeline node is configured to receive data from the second pipeline node on the second frequency and to concurrently retransmit the data to the fourth pipeline node on the first frequency.

16. The system of claim 1 in which the one or more data pipelines further includes a second data pipeline adjacent to the first data pipeline, and each pipeline node of the second data pipeline transmits on one of a third frequency and a fourth frequency, the third frequency and the fourth frequency being different from the first frequency and the second frequency.

17. The system of claim 16 in which the one or more data pipelines further includes a third data pipeline adjacent to the second data pipeline, and each pipeline node of the third data pipeline transmits on one of a fifth frequency and a sixth frequency, the fifth frequency and the sixth frequency being different from the first, second, third and fourth frequencies.

18. The system of claim 17 in which the one or more data pipelines further includes a fourth data pipeline adjacent to the third data pipeline, and each pipeline node of the fourth data pipeline transmits on one of the first frequency or the second frequency.

19. The system of claim 1 in which the data collection center is located generally in the center of the set of distributed nodes.

20. The system of claim 1 in which the distributed nodes are seismic sensor nodes.

21. The system of claim 1 in which the data collection center comprises an antenna for each data pipeline configurable to receive data from the respective data pipeline.

22. The system of claim 1 in which the data collection center comprises an optical fiber, cable, or other wired connection to a pipeline node of each data pipeline.

23. A method of receiving data at a data collection center from multiple radio transmitters, the radio transmitters configurable to transmit concurrently, and each radio transmitter configurable to transmit at a respective frequency, and each radio transmitter configurable to transmit a polarized signal, at least one of the radio transmitters transmitting from generally a first direction from the data collection center, and at least one of the radio transmitters transmitting from generally a second direction from the data collection center, the second direction being different from the first direction, the method comprising:
placing a receive antenna at the data collection center for each of the multiple radio transmitters;
configuring each radio transmitter generally in the first direction from the data collection center to transmit a signal at a frequency different from the respective frequencies of any other radio transmitters of the multiple radio transmitters generally in the first direction;
configuring each radio transmitter generally in the second direction from the data collection center to transmit a signal at a frequency different from the respective frequencies of any other radio transmitters of the multiple radio transmitters generally in the second direction, at least one radio transmitters generally in the second direction from the data collection center transmitting on substantially the same frequency as at least one radio transmitter generally in the first direction from the data center, but using a different polarization; and
configuring each receive antenna to receive at the respective frequency and polarization of the respective radio transmitter.

24. The method of claim 23 used in a seismic survey.
